(19) United States
(12) Patent Application Publication
(10) Pub. No.: US 2026/0361424 A1
(43) Pub. Date: Nov. 12, 2026

(54) SOUND WAVE INFORMATION OUTPUT DEVICE, SOUND WAVE INFORMATION OUTPUT METHOD, AND RECORDING MEDIUM

(71) Applicant: NEC Corporation, Tokyo (JP)

(72) Inventors: Hiroki TANAKA, Tokyo (JP); Shigeharu TSUKAGOSHI, Tokyo (JP); Minoru KOBAYASHI, Tokyo (JP)

(73) Assignee: NEC Corporation, Tokyo (JP)

(21) Appl. No.: 19/515,837

(22) PCT Filed: May 10, 2024
(86) PCT No.: PCT/JP2024/017334

§ 371 Date: Mar. 3, 2026

(30) Foreign Application Priority Data
Sep. 13, 2023 (JP) 2023-148124

(51) Int. Cl. H04B 11/00

(52) U.S. Cl. CPC H04B 11/00

(57) ABSTRACT

To improve accuracy of information of a transmission frequency of a sound wave transmitted from an emission source, a sound wave information output device estimates, based on generation of a target sound wave that is a sound wave transmitted underwater, an emission source velocity that is a moving direction and a moving speed of an emission source that emits the target sound wave, generates sound wave information including information of a transmission frequency of the target sound wave, based on the emission source velocity, a reception frequency of the target sound wave in a reception device that has received the target sound wave, a reception device velocity that is a moving direction and a moving speed of the reception device, and a sound speed in water around the reception device, and outputs the sound wave information.

### TECHNICAL FIELD

The present disclosure relates to a sound wave information output device, a sound wave information output method, and a recording medium.

### BACKGROUND ART

It is considered to perform communication using sound waves in water. Hereinafter, communication using sound waves in water may be referred to as underwater sound wave communication.

Since an amount of attenuation of radio waves is large in water, sound waves are more suitable for communication than radio waves in deep water.

In recent years, a method has been known in which a control device on land or on water communicates with a communication device in water via a base station floating on a water surface. In the method in which the control device communicates with the communication device in water via the base station floating on the water surface, communication between the base station and the communication device is performed by underwater sound wave communication. Communication between the base station and the control device is performed by radio wave communication or wired communication.

### CITATION LIST

### Patent Literature

PTL 1: JP 2017-076877 A

### SUMMARY OF INVENTION

### Technical Problem

In water, there is a possibility that a sound wave is generated other than a sound wave transmitted from the communication device or the base station. The communication device or the base station may perform some control according to information on the generated sound wave.

However, in a case where at least one of an emission source of the generated sound wave or a detection device that detects generation of the sound wave is moving, a transmission frequency of the sound wave in the emission source and a reception frequency of the sound wave in the detection device have different values. For example, in a case where control is performed by the communication device or the base station, based on the reception frequency having a value different from the transmission frequency, there is a possibility that appropriate control is not performed.

PTL 1 describes a calculation formula for determining a transmission frequency of a sound wave emitted from an underwater base station so that an observation frequency in an underwater robot is a target frequency. In this calculation formula, it is assumed that a moving velocity of the underwater base station is 0. For that reason, in a case where a moving velocity of the emission source of the sound wave is unknown, accuracy of calculation of the transmission frequency is low in a method described in PTL 1.

In view of the above-described problems, an object of the present disclosure is to provide a sound wave information output device, a sound wave information output method, and a recording means capable of improving accuracy of information of a transmission frequency of a sound wave transmitted from an emission source.

### Solution to Problem

In an aspect of the present disclosure, a sound wave information output device includes a velocity estimation means for estimating, based on generation of a target sound wave that is a sound wave transmitted underwater, an emission source velocity that is a moving direction and a moving speed of an emission source that emits the target sound wave, a generation means for generating sound wave information including information of a transmission frequency of the target sound wave, based on the emission source velocity, a reception frequency of the target sound wave in a reception device that has received the target sound wave, a reception device velocity that is a moving direction and a moving speed of the reception device, and a sound speed in water around the reception device, and an output means for outputting the sound wave information.

In another aspect of the present disclosure, a sound wave information output method estimates, based on generation of a target sound wave that is a sound wave transmitted underwater, an emission source velocity that is a moving direction and a moving speed of an emission source that emits the target sound wave, generates sound wave information including information of a transmission frequency of the target sound wave, based on the emission source velocity, a reception frequency of the target sound wave in a reception device that has received the target sound wave, a reception device velocity that is a moving direction and a moving speed of the reception device, and a sound speed in water around the reception device, and outputs the sound wave information.

In another aspect of the present disclosure, a sound wave information output program recorded on a computer-readable recording medium causes a computer to implement a velocity estimation function of estimating, based on generation of a target sound wave that is a sound wave transmitted underwater, an emission source velocity that is a moving direction and a moving speed of an emission source that emits the target sound wave, a generation function of generating sound wave information including information of a transmission frequency of the target sound wave, based on the emission source velocity, a reception frequency of the target sound wave in a reception device that has received the target sound wave, a reception device velocity that is a moving direction and a moving speed of the reception device, and a sound speed in water around the reception device, and an output function of outputting the sound wave information.

### Advantageous Effects of Invention

According to the above aspects of the present disclosure, it is possible to improve accuracy of information of a transmission frequency of a sound wave transmitted from an emission source.

### BRIEF DESCRIPTION OF DRAWINGS

FIG. 1 is a diagram illustrating a configuration example of a sound wave information output device of the present disclosure.

FIG. 2 is a diagram illustrating an example of an operation flow of the sound wave information output device of the present disclosure.

FIG. 3 is a diagram illustrating a configuration example of a communication system including a sound wave information output device of the present disclosure.

FIG. 4 is a diagram illustrating a configuration example of the sound wave information output device of the present disclosure.

FIG. 5 is a diagram illustrating another configuration example of the sound wave information output device of the present disclosure.

FIG. 6 is a diagram illustrating a relationship between an emission source velocity and a reception device velocity.

FIG. 7 is a diagram illustrating an example of sound wave information.

FIG. 8 is a diagram illustrating an example of an image indicating sound wave information.

FIG. 9 is a diagram illustrating a configuration example of a communication system including a sound wave information output device of the present disclosure.

FIG. 10 is a diagram illustrating a configuration example of the sound wave information output device of the present disclosure.

FIG. 11 is a diagram illustrating a hardware configuration example of the present disclosure.

### EXAMPLE EMBODIMENT

### First Example Embodiment

A description will be given of a first example embodiment of the present disclosure. A specific example of a sound wave information output device 10 in the first example embodiment is a sound wave information output device 20 in a second example embodiment described later.

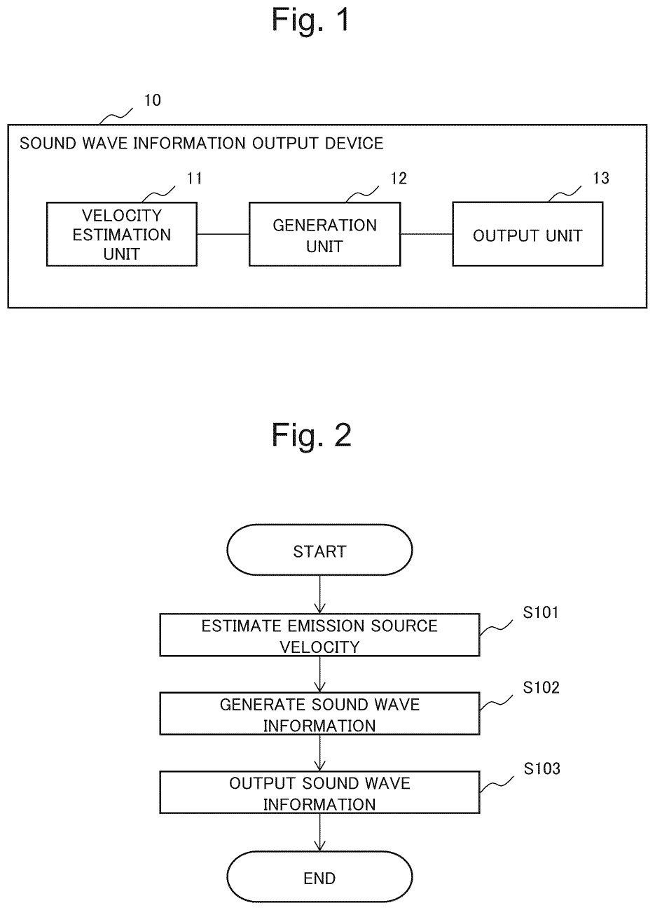

FIG. 1 illustrates a configuration example of the sound wave information output device 10. The sound wave information output device 10 includes a velocity estimation unit 11, a generation unit 12, and an output unit 13.

The velocity estimation unit 11 estimates an emission source velocity, based on generation of a target sound wave. The target sound wave is a sound wave transmitted underwater. The emission source velocity is a moving direction and a moving speed of an emission source that emits the target sound wave.

The generation unit 12 generates sound wave information, based on the emission source velocity, a reception frequency of the target sound wave in a reception device that has received the target sound wave, a reception device velocity, and a sound speed in water around the reception device. The reception device velocity is a moving direction and a moving speed of the reception device. The sound wave information is information regarding the target sound wave. The sound wave information includes information of a transmission frequency of the target sound wave. The reception frequency is a frequency of a sound wave received by the reception device, the frequency being received (observed) by the reception device.

The output unit 13 outputs the sound wave information.

Next, FIG. 2 illustrates an example of an operation flow of the sound wave information output device 10.

The velocity estimation unit 11 estimates the emission source velocity, based on the generation of the target sound wave (step S101).

The generation unit 12 generates the sound wave information (step S102).

The output unit 13 outputs the sound wave information (step S103).

As described above, in the first example embodiment of the present disclosure, the sound wave information output device 10 includes the velocity estimation unit 11, the generation unit 12, and the output unit 13. The velocity estimation unit 11 estimates the emission source velocity, based on the generation of the target sound wave. The target sound wave is the sound wave transmitted underwater. The emission source velocity is the moving direction and the moving speed of the emission source that emits the target sound wave. The generation unit 12 generates the sound wave information, based on the emission source velocity, the reception frequency of the target sound wave in the reception device that has received the target sound wave, the reception device velocity that is the moving direction and the moving speed of the reception device, and the sound speed in water around the reception device. The sound wave information includes the information of the transmission frequency of the target sound wave. The output unit 13 outputs the sound wave information.

As a result, the emission source velocity is estimated, and the sound wave information including the information of the transmission frequency of the target sound wave is generated, based on the estimated emission source velocity. For that reason, it is possible to improve accuracy of the information of the transmission frequency of the sound wave transmitted from the emission source.

### Second Example Embodiment

Next, a description will be given of a second example embodiment of the present disclosure. A specific example of the sound wave information output device 10 in the first example embodiment is the sound wave information output device 20 in the second example embodiment.

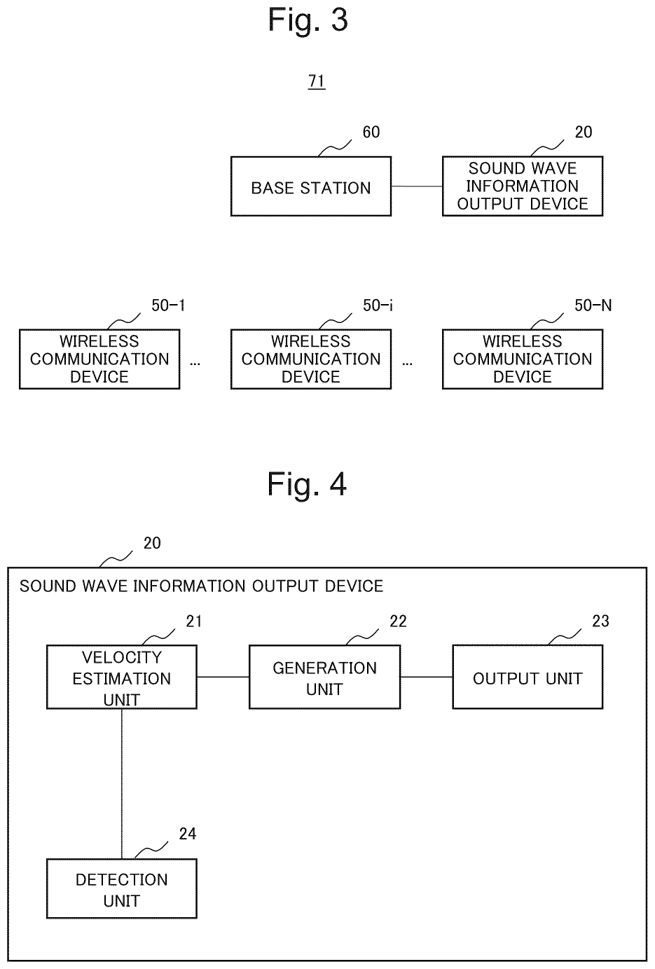

FIG. 3 illustrates a configuration example of a communication system 71 including the sound wave information output device 20. The communication system 71 includes the sound wave information output device 20, a base station 60, and a wireless communication device 50-i (i is an integer of 1 to N, and N is an integer of one or more).

The base station 60 is located on water. The base station 60 can perform wireless communication using sound waves with the wireless communication devices 50-i.

The wireless communication device 50-i is present underwater. The wireless communication device 50-i can perform wireless communication using sound waves with the base station 60. The wireless communication device 50-i can communicate with the sound wave information output device 20 via the base station 60. The wireless communication devices 50-1 to 50-N may be collectively referred to as a wireless communication device 50.

A frequency used by the wireless communication device 50-i for wireless communication using sound waves with the base station 60 is hereinafter referred to as a use frequency. The wireless communication using sound waves may be communication by a band signal. In this case, the use frequency may be a frequency band. In a case where the wireless communication is the communication by the band signal, the term “frequency” refers to a “frequency band”.

The sound wave information output device 20 is connected to the base station 60. The sound wave information output device 20 is located on water or land. The sound wave information output device 20 can perform, with the base station 60, wireless communication by a radio wave, or wired communication.

Next, FIG. 4 illustrates a configuration example of the sound wave information output device 20. The sound wave information output device 20 includes a velocity estimation unit 21, a generation unit 22, an output unit 23, and a detection unit 24.

The detection unit 24 detects generation of a target sound wave. The target sound wave is a sound wave transmitted underwater. The target sound wave is a sound wave as a target of output of sound wave information described later. Which sound wave is set as the target sound wave is determined in advance. For example, the target sound wave may be a sound wave transmitted underwater. The target sound wave may be a sound wave that is not used in wireless communication between the base station 60 and the wireless communication device 50. The target sound wave may be an interference wave. In a case where the target sound wave to be detected is an interference wave, the detection unit 24 detects generation of an interference wave with respect to wireless communication performed by the wireless communication device 50. The detection unit 24 can detect the generation of the target sound wave by any method. An example of a method of detecting the target sound wave will be described later.

The interference wave is a sound wave that has a possibility to interfere with wireless communication using sound waves, between the wireless communication device 50 present underwater and the base station 60. For example, a wave having a frequency close to a use frequency of wireless communication of the wireless communication device 50 can be an interference wave. In the case of wireless communication using sound waves, a sound wave used in communication performed by another service provider, natural sound, sound of construction performed on water, on land, or underwater, sound emitted by a vessel, or the like can also be an interference wave.

The velocity estimation unit 21 estimates an emission source velocity, based on the generation of the target sound wave. The emission source velocity is a moving direction and a moving speed of an emission source that emits the target sound wave. The emission source is an object that emits the target sound wave. For example, a device that performs communication by a sound wave, a living thing in water, construction equipment, a vessel, or the like can also be the emission source. The velocity estimation unit 21 considers that the target sound wave is generated in a case where the generation of the target sound wave is detected by the detection unit 24. An example of a method of estimating the emission source velocity will be described later. Estimating the emission source velocity, based on the generation of the target sound wave includes estimating the emission source velocity, based on reception of the target sound wave.

The generation unit 22 generates sound wave information, based on the emission source velocity, a reception frequency of the target sound wave in a reception device, a reception device velocity, and a sound speed in water around the reception device. The reception device velocity is a moving direction and a moving speed of the reception device. The reception device is a device that has received the target sound wave. The reception device is the base station 60, the wireless communication device 50, or an information collection device. The sound wave information is information regarding the target sound wave. The sound wave information includes information of a transmission frequency of the target sound wave. The reception frequency is a frequency of a sound wave received by the reception device, the frequency being received (observed) by the reception device. An example of a method of generating the sound wave information will be described later.

The output unit 23 outputs the sound wave information. A method of outputting the sound wave information will be described later.

Next, a description will be given of a method of detecting the generation of the target sound wave. The detection unit 24 may detect, as the target sound wave, generation of an interference wave with respect to wireless communication performed by the wireless communication device 50. As for the method of detecting the target sound wave, there is a method of detecting the target sound wave, based on a sound wave received by the base station 60, and a method of detecting the target sound wave, based on a sound wave received by the wireless communication device 50.

First, a description will be given of the method of detecting the target sound wave, based on a sound wave received by the base station 60.

In this case, the base station 60 transmits information on the sound wave to the sound wave information output device 20. The information on the sound wave includes information of an arrival direction of the sound wave and information of a frequency of the sound wave (reception frequency in the base station 60). In a case where the target sound wave is a sound wave that is not used in communication with the wireless communication devices 50-1 to 50-N, the base station 60 does not have to transmit information on the sound waves that are used in communication with the wireless communication devices 50-1 to 50-N. In a case where the target sound wave is an interference wave, the base station 60 does not have to transmit information on the sound wave having a frequency that does not affect the use frequencies of the wireless communication devices 50-1 to 50-N.

For example, the detection unit 24 of the sound wave information output device 20 can consider that the target sound wave is generated in a case where the base station 60 receives any of the following sound waves.
A sound wave arriving from a direction in which the wireless communication devices 50-1 to 50-N are not present
A sound wave arriving from a direction in which a wireless communication device among the wireless communication devices 50-1 to 50-N is present, the sound wave having a frequency different from a use frequency of the wireless communication device present in the direction
A sound wave having unknown identification information

The detection unit 24 can regard, as an interference wave, for example, a sound wave having a frequency that affects a use frequency of a wireless communication device among the wireless communication devices 50-1 to 50-N among the above sound waves.

Next, a description will be given of the method of detecting the target sound wave, based on a sound wave received by the wireless communication device 50-i.

In this case, the wireless communication device 50-i transmits information on the sound wave to the sound wave information output device 20 via the base station 60. The information on the sound wave includes information of an arrival direction of the sound wave and information of a frequency of the sound wave (reception frequency in the wireless communication device 50-i). In a case where the target sound wave is a sound wave that is not used in communication with the wireless communication devices 50-1 to 50-N, about a sound wave that is used in communication with the base station 60, the wireless communication device 50-i does not have to transmit information on the sound wave. In a case where the target sound wave is an interference wave, about a sound wave having a frequency that does not affect the use frequencies of the wireless communication devices 50-1 to 50-N, the wireless communication device 50-i does not have to transmit information on the sound wave.

When being affected by the interference wave, the wireless communication device 50-i cannot communicate at the original use frequency. For that reason, in a case where communication cannot be performed at the original use frequency, the wireless communication device 50-i communicates with the base station 60 at a frequency that is not affected by the interference wave among spare frequencies.

The detection unit 24 of the sound wave information output device 20 can consider that the target sound wave is generated in a case where the wireless communication device 50-i receives the target sound wave. The detection unit 24 can consider that an interference wave is generated in a case where the wireless communication device 50-i receives a sound wave that has a possibility to interfere with wireless communication using sound waves, between the base station 60 and the wireless communication device 50.

The detection unit 24 may detect the target sound wave, based on the sound wave received by an information acquisition device (not illustrated). The information acquisition device is mounted on, for example, an unmanned underwater vehicle (UUV) for information acquisition. In this case, the information acquisition device can detect the target sound wave by a method similar to the method of detecting the target sound wave, based on the sound wave received by the wireless communication device 50-i.

Next, a description will be given of an example of the method of estimating the emission source velocity.

For example, the velocity estimation unit 21 may estimate the emission source velocity by using position information of a vessel present in a predetermined range from the reception device. The predetermined range is, for example, a range in which there is a possibility that the reception device receives a sound wave transmitted from the range. The predetermined range may be fixedly determined in advance. The velocity estimation unit 21 may receive the position information of the vessel from a server (not illustrated) that provides the position information of the vessel. The information provided from the server may be, for example, information by an Automatic Identification System (AIS). The position information of the vessel may be position information of the vessel visually confirmed by a surveillance staff on land. The position information of the vessel may include a history of position information in the past. The velocity estimation unit 21 may further receive identification information of the vessel from the server.

In a case where the position information of the vessel is used, the velocity estimation unit 21 may estimate a vessel that is an emission source that emits the target sound wave, based on, for example, the position information of the vessel and an arrival direction of the target sound wave. The arrival direction of the target sound wave is an arrival direction of the target sound wave with respect to a device that has received the target sound wave.

For example, the velocity estimation unit 21 may estimate a vessel present in the arrival direction of the target sound wave as an emission source that emits the target sound wave. In a case where two or more vessels are present in the arrival direction of the target sound wave, the velocity estimation unit 21 may estimate two or more vessels as candidates for the emission source. The velocity estimation unit 21 may exclude a vessel that is no longer present in the arrival direction of the target sound wave from the candidates for the emission source, based on a temporal change in the arrival direction of the target sound wave.

The velocity estimation unit 21 may estimate the vessel that is the emission source, based on, for example, position information of the vessel and a position of the emission source. For example, the velocity estimation unit 21 may estimate a vessel present within a predetermined range from the position of the emission source as an emission source that emits the target sound wave. In a case where there are two or more vessels within a predetermined range from the position of the emission source, the velocity estimation unit 21 may narrow down vessels estimated as candidates for the emission source, based on a temporal change in the position of the emission source. The velocity estimation unit 21 may estimate two or more vessels as candidates for the emission source.

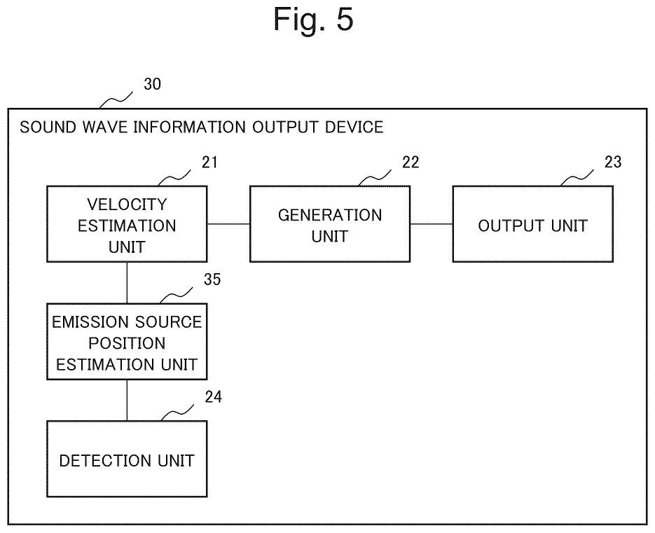

The position of the emission source is estimated by an emission source position estimation unit 35. The emission source position estimation unit 35 estimates a position (emission source position) of an emission source that emits the target sound wave detected by the detection unit 24. FIG. 5 illustrates a configuration example of a sound wave information output device 30 including the emission source position estimation unit 35. The sound wave information output device 30 includes the emission source position estimation unit 35 in addition to the velocity estimation unit 21, the generation unit 22, the output unit 23, and the detection unit 24. A method of estimating the position of the emission source will be described later.

The velocity estimation unit 21 uses a moving velocity of a vessel estimated as an emission source as the emission source velocity. For example, the velocity estimation unit 21 can estimate the emission source velocity, based on a temporal change in a position of the vessel estimated as the emission source. The velocity estimation unit 21 may use information of the moving velocity of the vessel included in the information by the AIS as information of the emission source velocity. In a case where two or more vessels are estimated as candidates for the emission source, the velocity estimation unit 21 may set the moving velocity of each of the candidates for the emission source as a candidate for the emission source velocity.

There may be a case where emission source is not a vessel. For that reason, the velocity estimation unit 21 may not be able to estimate the vessel that is the emission source. For example, there may be no vessel in the arrival direction of the target sound wave. Thus, in a case where the vessel that is the emission source cannot be estimated, it is preferable for the velocity estimation unit 21 to estimate the emission source velocity by another method.

For example, the velocity estimation unit 21 may estimate the emission source velocity, based on a temporal change of the emission source position estimated by the emission source position estimation unit 35. The velocity estimation unit 21 may estimate the emission source velocity, based on a temporal change in the arrival direction of the target sound wave.

Next, a description will be given of the method of estimating the position of the emission source. The position of the emission source is estimated by the emission source position estimation unit 35.

For example, the detection unit 24 receives, from the base station 60, information on the target sound wave received by the base station 60. The information on the target sound wave includes information of the arrival direction and the frequency (reception frequency) of the target sound wave. The detection unit 24 receives, from the wireless communication device 50-i, information on the target sound wave received by the wireless communication device 50-i. The emission source position estimation unit 35 estimates the position of the emission source by using pieces of information on the target sound wave estimated to be the target sound wave from the same source among pieces of information on the target sound wave received by the detection unit 24. For example, the emission source position estimation unit 35 can set an intersection of straight lines extending in the arrival direction of the target sound wave from positions of devices (reception devices) that have received the target sound wave as the position of the emission source. The emission source position estimation unit 35 may regard, for example, target sound waves of the same frequency as target sound waves from the same source.

A position of the wireless communication device 50-i may be measured based on an inertial sensor included in the wireless communication device 50-i.

The velocity estimation unit 21 can estimate the position of the wireless communication device 50-i, based on, for example, the arrival direction of the sound wave emitted by the wireless communication device 50-i to the base station 60. For example, the velocity estimation unit 21 receives, from the base station 60, information of the arrival direction of the sound wave emitted by the wireless communication device 50-i. The velocity estimation unit 21 receives, via the base station 60, from the wireless communication device 50-i, information of a position (depth) in the vertical direction of the wireless communication device 50-i. Then, the velocity estimation unit 21 can estimate the position of the wireless communication device 50-i, based on the information of the arrival direction and the information of the position (depth) in the vertical direction. In this case, the wireless communication device 50-i includes a pressure (depth) sensor.

The emission source position estimation unit 35 may estimate the position of the emission source, further based on a received signal level of the target sound wave. In this case, the information on the target sound wave further includes information of the received signal level at a device that has received the target sound wave.

Next, a description will be given of an example of the method of generating the sound wave information. The generation unit 22 generates the sound wave information, based on the emission source velocity, the reception frequency of the target sound wave in the reception device, the reception device velocity, and the sound speed in water around the reception device. The reception device is the wireless communication device 50, the base station 60, or the information acquisition device.

For example, the generation unit 22 can calculate a transmission frequency f0 of the target sound wave at the emission source by the following formula (1). Note that a reception frequency of the target sound wave in the reception device is represented by f. A sound speed is represented by Vc. A speed of the reception device is represented by r. A speed of the emission source is represented by t.

$$[ Math . 1 ]$$

$${f}_{0} = \frac{{V}_{c} - t}{{V}_{c} - r} f \qquad ( 1 )$$

The generation unit 22 uses, as the speed t of the emission source, a component of an emission source velocity t0 (vector) in a direction of a straight line from the emission source toward the reception device. When a traveling direction of the emission source with respect to the straight line from the emission source toward the reception device is θt, the speed t of the emission source is calculated by the following formula (2). The generation unit 22 can grasp the direction of the straight line from the emission source toward the reception device from information of the arrival direction of the target sound wave with respect to the reception device. The emission source velocity t0 is estimated by the velocity estimation unit 21.

[Math. 2]

t=t₀ cos θₜ (2)

The generation unit 22 uses, as the speed r of the reception device, a component of a reception device velocity r0 (vector) in the direction of the straight line from the emission source toward the reception device. When a traveling direction of the reception device with respect to the straight line from the emission source toward the reception device is θr, the speed r of the reception device is calculated by the following formula (3). The reception device velocity r0 is acquired by the reception device and transmitted to the sound wave information output device 20.

[Math. 3]

□=□₀ cos □_{□} (3)

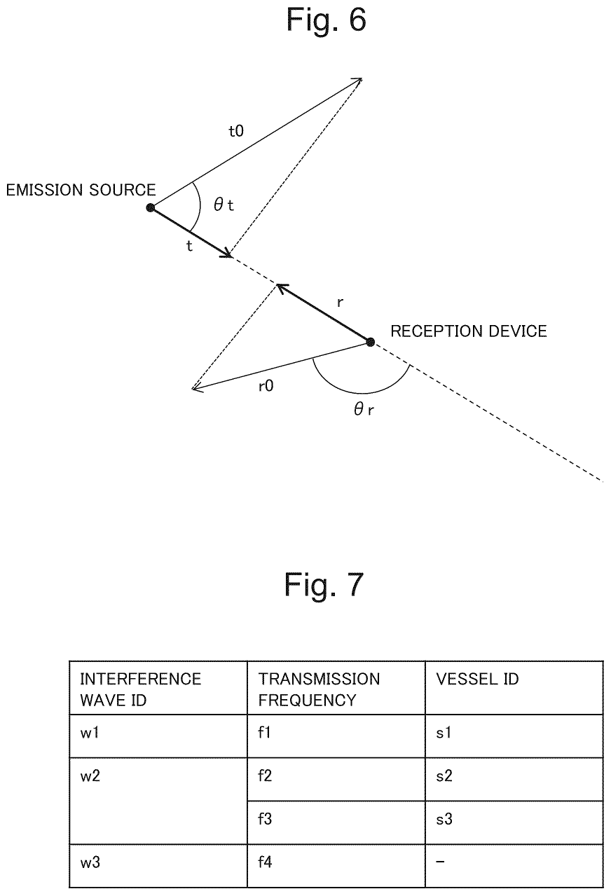

FIG. 6 illustrates a relationship between the emission source velocity and the reception device velocity.

The generation unit 22 estimates the sound speed Vc and calculates the transmission frequency f0 by using the estimated sound speed Vc. A method of estimating the sound speed will be described later.

In a case where the velocity estimation unit 21 estimates two or more velocities as candidates for the emission source velocity, the generation unit 22 calculates the transmission frequency f0 for each of the candidates for the emission source velocity. Then, the generation unit 22 sets each of the calculated transmission frequencies as a candidate for the transmission frequency. In a case where the calculated transmission frequencies include an invalid transmission frequency (transmission frequency out of a predetermined frequency range), the generation unit 22 may exclude the invalid transmission frequency from the candidates for the transmission frequency. An emission source velocity used to calculate the transmission frequency excluded from the candidates for the transmission frequency may be excluded from the candidates for the emission source velocity.

Then, the generation unit 22 generates the sound wave information. The sound wave information includes information of the transmission frequency. In a case where two or more transmission frequencies are estimated as candidates for the transmission frequency, the sound wave information may include information of each of the candidates for the transmission frequency. In a case where two or more target sound waves are detected, the sound wave information may include information about each of the target sound waves or may be generated for each of the target sound waves.

The sound wave information may include information of the emission source velocity used to calculate the transmission frequency. In a case where the position information of the vessel is used for estimation of the emission source velocity, the sound wave information may include identification information of the vessel whose position information is used for the estimation of the emission source velocity. The sound wave information may include metadata acquired from the target sound wave. The metadata is acquired by the reception device and transmitted to the sound wave information output device 20. The sound wave information may include information of a time when the target sound wave is received by the reception device.

The sound wave information may include spectrum information indicating a frequency spectrum of the target sound wave. The spectrum information indicates a correspondence relationship between the frequency and the intensity of the target sound wave. The spectrum information of the reception frequency in the reception device is acquired by the reception device and transmitted to the sound wave information output device 20. The generation unit 22 may convert the spectrum information of the reception frequency in the reception device into spectrum information of the transmission frequency by a method similar to the above-described calculation of the transmission frequency.

The information of the transmission frequency may be associated with the emission source velocity. In a case where the emission source is a vessel, if a moving speed of the vessel changes, a transmission frequency of a sound wave emitted by the vessel may change according to a speed of rotation of the screw. For that reason, for example, the sound wave information may include information of the transmission frequency associated with the emission source velocity or with a speed component of the emission source velocity so that a device at an output destination of the sound wave information can perform prediction of the transmission frequency according to the moving speed of the vessel, or the like.

Next, a description will be given of the method of estimating the sound speed.

As for the sound speed around the reception device, for example, the sound speed in the ocean depends on a water temperature, a pressure (depth), and a salinity concentration. For that reason, the generation unit 22 may estimate sound speed distributions in the vertical direction and the horizontal direction, based on at least one of the water temperature or the salinity concentration around the reception device. The generation unit 22 may receive, from the information acquisition device (not illustrated), information (the water temperature, the salinity concentration, and the like) acquired by the information acquisition device and estimate the sound speed distributions in the vertical direction and the horizontal direction, based on the received information.

The information acquisition device acquires information of a depth of the information acquisition device. The information acquisition device acquires information of at least one of the water temperature or the salinity concentration around the information acquisition device. For example, the information collection device includes a depth sensor, and acquires information of the depth of the information acquisition device. For example, the information acquisition device includes a water temperature sensor, and acquires the information of the water temperature around the information acquisition device. For example, the information acquisition device includes a salinity concentration sensor, and acquires the information of the salinity concentration around the information acquisition device. The information acquisition device may be the wireless communication device 50-i.

As for a position of the information acquisition device, a Global Navigation Satellite System (GNSS) cannot be used in water. For that reason, the generation unit 22 may estimate the position of the information acquisition device, based on the arrival direction of a sound wave emitted by the information acquisition device with respect to the base station 60. For example, the generation unit 22 receives, from the base station 60, information of the arrival direction of the sound wave emitted by the information acquisition device. The generation unit 22 receives, via the base station 60, from the information acquisition device, information of a position (depth) in the vertical direction of the information acquisition device. Then, the generation unit 22 can estimate the position of the information acquisition device, based on the information of the arrival direction and the information of the position (depth) in the vertical direction.

Alternatively, the generation unit 22 may receive information from an information server (not illustrated). The information server may estimate the current water temperature and salinity concentration at a predetermined position, based on, for example, information of the water temperature and salinity concentration in the past.

The generation unit 22 can receive the information of the position (depth) in the vertical direction from the wireless communication device 50-i. The wireless communication device 50-i includes a pressure (depth) sensor and acquires information of the position (depth) in the vertical direction of the wireless communication device 50-i. The generation unit 22 estimates the position of the wireless communication device 50-i in a similar manner to the above-described method.

Next, a description will be given of the method of outputting the sound wave information.

For example, the output unit 23 may output the sound wave information to a storage means inside or outside the sound wave information output device 20 and cause the storage means to store the sound wave information.

FIG. 7 illustrates an example of the sound wave information stored in the storage means. In the example illustrated in FIG. 7, information of the transmission frequency is stored for each of the target sound waves. The information of the transmission frequency is associated with a target sound wave identification (ID). The target sound wave ID is identification information given to each of the detected target sound waves. A vessel ID is identification information of a vessel.

The output unit 23 may output the sound wave information to a control device (not illustrated) that controls the base station 60 or the wireless communication device 50. Then, the control device may control the base station 60 or the wireless communication device 50, based on the sound wave information. For example, the control device may take an interference avoidance measure based on the transmission frequency of the target sound wave. For example, the control device may predict a time of generation of the target sound wave, based on the sound wave information, and perform control based on the predicted time of generation.

The output unit 23 may output, as the sound wave information, image information for displaying an image on a display means (not illustrated). The image displayed on the display means may be obtained by superimposing an image indicating an emission source on a map.

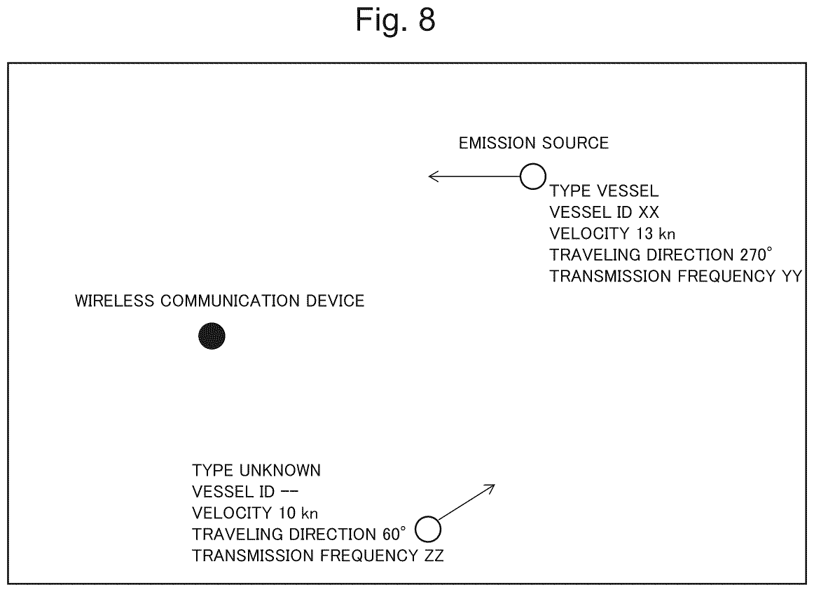

FIG. 8 illustrates an example of an image indicating sound wave information. In FIG. 8, a black circle indicates a position of a wireless communication device. A white circle indicates a position of an emission source of the target sound wave. An arrow indicates a traveling direction. In the example of FIG. 8, the sound wave information is illustrated on a two-dimensional map, but may be illustrated three-dimensionally. The image includes information of the transmission frequency of the emission source calculated by the generation unit 22.

As described above, since the sound wave information output device 20 estimates the emission source velocity of the target sound wave, it is possible to estimate the transmission frequency at the emission source by using the estimated emission source velocity. For that reason, it is possible to improve accuracy of the information of the transmission frequency.

The accuracy of the information of the transmission frequency is improved, whereby control using the sound wave information (including the information of the transmission frequency) output from the sound wave information output device 20 is more appropriately performed. For example, in a case where the target sound wave is an interference wave, the interference avoidance measure is more appropriately performed. It is possible to improve estimation accuracy, for example, in a case where sound wave information about the same sound wave is estimated based on the transmission frequency from among two or more pieces of sound wave information.

Next, a description will be given of an example of an operation flow of the sound wave information output device 20 with reference to FIG. 2.

The detection unit 24 detects the generation of the target sound wave.

The velocity estimation unit 21 estimates the emission source velocity in a case where the generation of the target sound wave is detected by the detection unit 24 (step S101).

The generation unit 22 generates the sound wave information (step S102).

The output unit 23 outputs the sound wave information (step S103).

As described above, in the second example embodiment of the present disclosure, the sound wave information output device 20 includes the velocity estimation unit 21, the generation unit 22, and the output unit 23. The velocity estimation unit 21 estimates the emission source velocity, based on the generation of the target sound wave. The target sound wave is a sound wave transmitted underwater. The emission source velocity is the moving direction and the moving speed of the emission source that emits the target sound wave. The generation unit 22 generates the sound wave information, based on the emission source velocity, the reception frequency of the target sound wave in the reception device that has received the target sound wave, the reception device velocity that is the moving direction and the moving speed of the reception device, and the sound speed in water around the reception device. The sound wave information includes the information of the transmission frequency of the target sound wave. The output unit 23 outputs the sound wave information.

As a result, the emission source velocity is estimated, and the sound wave information including the information of the transmission frequency of the target sound wave is generated, based on the estimated emission source velocity. For that reason, it is possible to improve the accuracy of the information of the transmission frequency of the sound wave transmitted from the emission source.

The velocity estimation unit 21 may estimate the emission source velocity, based on the position information of the vessel present in the predetermined range from the reception device. The velocity estimation unit 21 may estimate, as the emission source of the target sound wave, the vessel present in the arrival direction of the target sound wave with respect to the reception device. As a result, the sound wave information output device 20 can implement the estimation of the emission source velocity.

In a case where there is a plurality of vessels in the arrival direction of the target sound wave, the velocity estimation unit 21 may exclude the vessel that is no longer present in the arrival direction of the emission source from the candidates for the emission source, based on the temporal change in the arrival direction of the target sound wave. As a result, it is possible to improve accuracy of the estimation of the emission source velocity.

The sound wave information output device 30 may further include the emission source position estimation unit 35 for estimating the emission source position that is the position of the emission source. The velocity estimation unit 21 may estimate the emission source velocity, based on the temporal change in the emission source position. As a result, the sound wave information output device 30 can implement the estimation of the emission source velocity.

The generation unit 22 may estimate the sound speed, based on the water temperature. The generation unit 22 may estimate the sound speed, further based on the salinity concentration around the reception device. As a result, the generation unit 22 can estimate the sound speed more accurately and calculate the transmission frequency more accurately.

The target sound wave may be a sound wave that is not used in wireless communication using sound waves, between the wireless communication device present underwater and the base station. In this case, the output unit 23 can output sound wave information about the sound wave that is not used in wireless communication using sound waves, between the wireless communication device present underwater and the base station.

The target sound wave may be an interference wave that is a sound wave that has a possibility to interfere with wireless communication using sound waves, between the wireless communication device present underwater and the base station. In this case, the output unit 23 can output sound wave information about the interference wave.

The sound wave information output device 20 may include the detection unit 24 for detecting the target sound wave. In this case, the sound wave information output device 20 can perform detection of the generation of the target sound wave by the sound wave information output device 20. The detection of the generation of the target sound wave may be performed outside the sound wave information output device 20.

### Third Example Embodiment

Next, a description will be given of a third example embodiment of the present invention. A specific example of the sound wave information output device 10 in the first example embodiment is a sound wave information output device 40 in the third example embodiment.

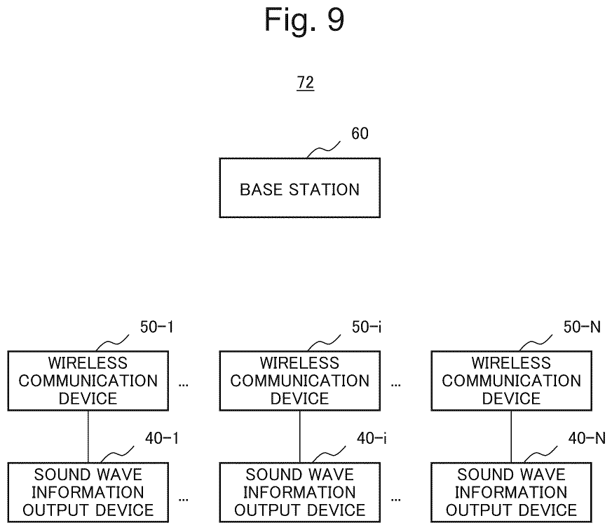

FIG. 9 illustrates a configuration example of a communication system 72 including the sound wave information output device 40. The communication system 72 includes the base station 60, the wireless communication device 50-i (i is an integer of 1 to N, and N is an integer of one or more), and a sound wave information output device 40-i. The sound wave information output device 40-i is connected to the corresponding wireless communication device 50-i. The sound wave information output devices 40-1 to 40-N may be collectively referred to as a sound wave information output device 40.

Since the base station 60 and the wireless communication device 50 are similar to those of the second example embodiment, the description thereof will be omitted.

The sound wave information output device 40-i is connected to the wireless communication device 50-i. The sound wave information output device 40-i is mounted on, for example, the same UUV on which the wireless communication device 50-i is mounted.

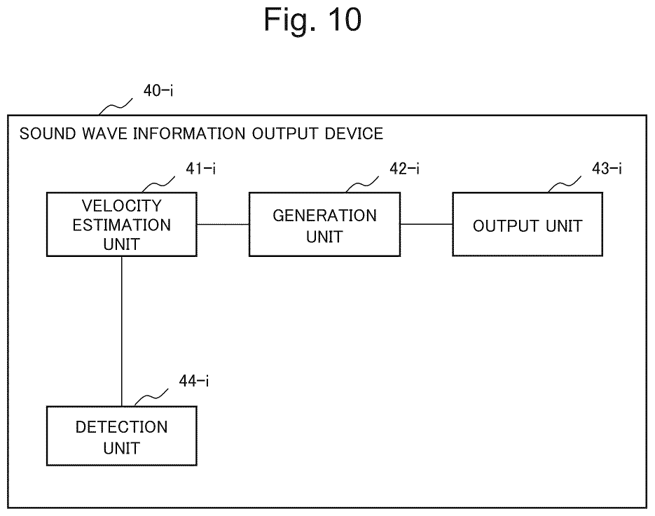

Next, FIG. 10 illustrates a configuration example of the sound wave information output device 40-i. The sound wave information output device 40-i includes a velocity estimation unit 41-i, a generation unit 42-i, an output unit 43-i, and a detection unit 44-i.

The detection unit 44-i detects generation of a target sound wave. The target sound wave may be a sound wave that is not used in wireless communication using sound waves, between the wireless communication device 50 present underwater and the base station 60. The target sound wave may be an interference wave with respect to wireless communication performed by the wireless communication device 50-i. The detection unit 44-i can detect the generation of the target sound wave by any method. For example, the detection unit 44-i detects the target sound wave, based on a sound wave received by the wireless communication device 50-i connected to the sound wave information output device 40-i. In a case where the target sound wave is an interference wave, the detection unit 44-i does not have to detect, as the target sound wave, a sound wave that does not affect a sound wave used for the wireless communication between the wireless communication device 50-i and the base station 60.

The velocity estimation unit 41-i estimates an emission source velocity, based on the generation of the target sound wave. The velocity estimation unit 41-i considers that the target sound wave is generated in a case where the generation of the target sound wave is detected by the detection unit 44-i.

Similarly to the second example embodiment, the velocity estimation unit 41-i may estimate the emission source velocity by using position information of a vessel. The velocity estimation unit 41-i can receive the position information of the vessel from a server that provides the position information of the vessel via the base station 60 and the wireless communication device 50-i.

The velocity estimation unit 41-i may estimate the emission source velocity, based on a temporal change in an arrival direction of the target sound wave. The velocity estimation unit 41-i may estimate the emission source velocity, based on a temporal change in a position of an emission source. The sound wave information output device 40 may include an emission source position estimation unit similarly to the sound wave information output device 30 (FIG. 5) described in the second example embodiment.

A position of the wireless communication device 50-i may be measured based on an inertial sensor included in the wireless communication device 50-i.

The velocity estimation unit 41-i can also estimate the position of the wireless communication device 50-i, based on, for example, an arrival direction of the sound wave emitted by the base station 60 with respect to the wireless communication device 50-i. For example, the velocity estimation unit 41-i receives information of the arrival direction of the sound wave emitted by the base station 60 from the wireless communication device 50-i. The velocity estimation unit 41-i receives, from the wireless communication device 50-i, information of a position (depth) in the vertical direction of the wireless communication device 50-i. Then, the velocity estimation unit 41-i can estimate the position of the wireless communication device 50-i, based on the information of the arrival direction, the information of the position (depth) in the vertical direction, and position information of the base station 60. In this case, the wireless communication device 50-i includes a pressure (depth) sensor.

The generation unit 42-i generates sound wave information, based on the emission source velocity, a reception frequency of the target sound wave in a reception device that has received the target sound wave, a reception device velocity, and a sound speed in water around the reception device. The sound wave information includes the information of the transmission frequency of the target sound wave. In the present example embodiment, the reception device is the wireless communication device 50-i. Since the method of calculating the transmission frequency is similar to that of the second example embodiment, the description thereof will be omitted.

The output unit 43-i outputs the sound wave information. The output unit 43-i may output the sound wave information to a storage means (not illustrated) connected to the base station 60 via the base station 60 and the wireless communication device 50-i.

Next, a description will be given of an example of an operation flow of the sound wave information output device 40-i with reference to FIG. 2.

The detection unit 44-i detects the generation of the target sound wave.

The velocity estimation unit 41-i estimates the emission source velocity in a case where the target sound wave is detected by the detection unit 44-i (step S101).

The generation unit 42-i generates the sound wave information (step S102).

The output unit 43-i outputs the sound wave information (step S103).

As described above, in the third example embodiment of the present disclosure, the sound wave information output device 40-i includes the velocity estimation unit 41-i, the generation unit 42-i, and the output unit 43-i. The velocity estimation unit 41-i estimates the emission source velocity, based on the generation of the target sound wave. The target sound wave is a sound wave transmitted underwater. The emission source velocity is a moving direction and a moving speed of an emission source that emits the target sound wave. The generation unit 42-i generates the sound wave information, based on the emission source velocity, the reception frequency of the target sound wave in the reception device that has received the target sound wave, the reception device velocity that is a moving direction and a moving speed of the reception device, and the sound speed in water around the reception device. The sound wave information includes the information of the transmission frequency of the target sound wave. The output unit 43-i outputs the sound wave information.

As a result, the emission source velocity is estimated, and the sound wave information including the information of the transmission frequency of the target sound wave is generated, based on the estimated emission source velocity. For that reason, it is possible to improve accuracy of the information of the transmission frequency of the sound wave transmitted from the emission source.

### Hardware Configuration Example

A description will be given of a configuration example of a hardware resource that implements, by using one information processing device (computer), the sound wave information output device (10, 20, 30, 40) in each example embodiment of the present disclosure described above. The sound wave information output device may be implemented physically or functionally by using at least two information processing devices. The sound wave information output device may be implemented as a dedicated device. Only some of the functions of the sound wave information output device may be implemented by using the information processing device. At least some of the functions of the sound wave information output device may be implemented on a cloud.

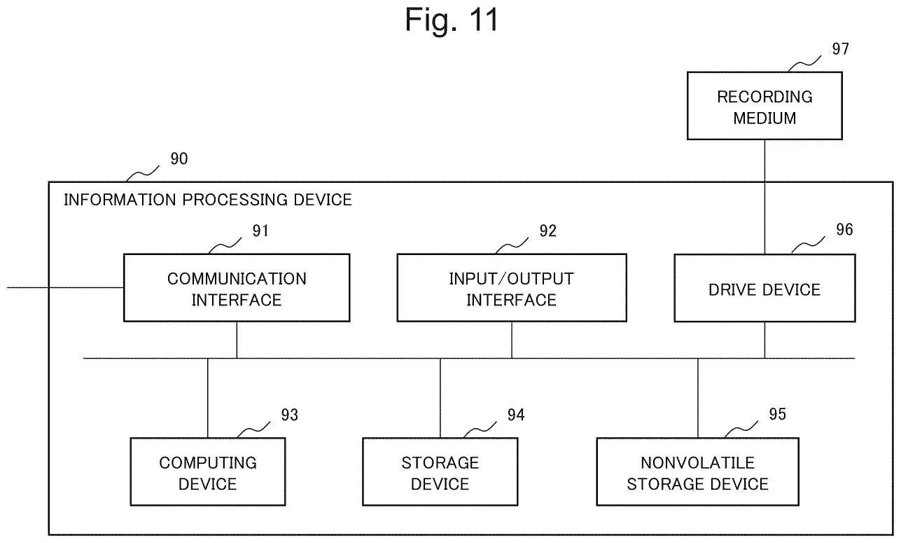

FIG. 11 is a diagram schematically illustrating a hardware configuration example of an information processing device capable of implementing the sound wave information output device of each example embodiment of the present disclosure. An information processing device 90 includes a communication interface 91, an input/output interface 92, a computing device 93, a storage device 94, a nonvolatile storage device 95, and a drive device 96.

For example, the output unit 13 in FIG. 1 can be implemented by the communication interface 91 and the computing device 93. The velocity estimation unit 11 and the generation unit 12 can be implemented by the computing device 93.

The communication interface 91 is a communication means for the sound wave information output device of each example embodiment to communicate with an external device in a wired or/and wireless manner. In a case where the sound wave information output device is implemented by using at least two information processing devices, the information processing devices may be connected to each other to be capable of communicating with each other via the communication interface 91.

The input/output interface 92 is a man-machine interface such as a keyboard as an example of an input device and a display as an output device.

The computing device 93 is implemented by an arithmetic processing device such as a general-purpose Central Processing Unit (CPU) or a microprocessor, and a plurality of electric circuits. For example, the computing device 93 can read various programs stored in the nonvolatile storage device 95 into the storage device 94 and execute processing according to the read program.

The storage device 94 is a memory device such as a Random Access Memory (RAM) that can be referred to from the computing device 93, and stores programs, various data, and the like. The storage device 94 may be a volatile memory device.

The nonvolatile storage device 95 is a nonvolatile storage device, for example, a Read Only Memory (ROM), a flash memory, or the like, and can store various programs, data, and the like.

The drive device 96 is, for example, a device that processes reading and writing of data on a recording medium 97 described later.

The recording medium 97 is any recording medium capable of recording data, for example, an optical disk, a magneto-optical disk, a semiconductor flash memory, or the like.

Each example embodiment of the present disclosure may be implemented, for example, by configuring a sound wave information output device with the information processing device 90 exemplified in FIG. 11 and supplying the sound wave information output device with a program capable of implementing the functions described in each example embodiment.

In this case, the computing device 93 can execute the program supplied to the sound wave information output device to implement the example embodiment. Not all but some of the functions of the sound wave information output device can also be configured by the information processing device 90.

Further, the program may be recorded in the recording medium 97, and the sound wave information output device may be configured so that the program is appropriately stored in the nonvolatile storage device 95 at a shipment stage, an operation stage, or the like of the sound wave information output device. In this case, as a method of supplying the program, a method may be adopted of installing the program in the sound wave information output device by using an appropriate jig at a manufacturing stage before shipment, an operation stage, or the like. As the method of supplying the program, a general procedure may also be adopted such as a method of downloading the program from the outside via a communication line such as the Internet.

Some or all of the above example embodiments may be described as the following supplementary notes, but are not limited to the following.

### (Supplementary Note 1)

A sound wave information output device comprising:
a velocity estimation means for estimating, based on generation of a target sound wave that is a sound wave transmitted underwater, an emission source velocity that is a moving direction and a moving speed of an emission source that emits the target sound wave;
a generation means for generating sound wave information including information of a transmission frequency of the target sound wave, based on the emission source velocity, a reception frequency of the target sound wave in a reception device that has received the target sound wave, a reception device velocity that is a moving direction and a moving speed of the reception device, and a sound speed in water around the reception device; and
an output means for outputting the sound wave information.

### (Supplementary Note 2)

The sound wave information output device according to Supplementary Note 1, wherein
the velocity estimation means estimates the emission source velocity, based on position information of a vessel present in a predetermined range from the reception device.

### (Supplementary Note 3)

The sound wave information output device according to Supplementary Note 2, wherein
the velocity estimation means estimates, as the emission source of the target sound wave, a vessel present in an arrival direction of the target sound wave with respect to the reception device.

### (Supplementary Note 4)

The sound wave information output device according to Supplementary Note 3, wherein
in a case where a plurality of vessels is present in the arrival direction of the target sound wave, the velocity estimation means excludes a vessel that is no longer present in an arrival direction of the emission source from candidates for the emission source, based on a temporal change in the arrival direction of the target sound wave.

### (Supplementary Note 5)

The sound wave information output device according to any one of Supplementary Notes 1 to 4, further comprising
an emission source position estimation means for estimating an emission source position that is a position of the emission source, wherein
the velocity estimation means estimates the emission source velocity, based on a temporal change in the emission source position.

### (Supplementary Note 6)

The sound wave information output device according to any one of Supplementary Notes 1 to 5, wherein
the generation means estimates the sound speed, based on a water temperature.

### (Supplementary Note 7)

The sound wave information output device according to Supplementary Note 6, wherein
the generation means estimates the sound speed, further based on a salinity concentration around the reception device.

### (Supplementary Note 8)

The sound wave information output device according to any one of Supplementary Notes 1 to 7, wherein
the target sound wave is a sound wave not used in wireless communication using sound waves, between a wireless communication device present underwater and a base station.

### (Supplementary Note 9)

The sound wave information output device according to any one of Supplementary Notes 1 to 7, wherein
the target sound wave is an interference wave that is a sound wave that has a possibility to interfere with wireless communication using sound waves, between a wireless communication device present underwater and a base station.

### (Supplementary Note 10)

The sound wave information output device according to any one of Supplementary Notes 1 to 9, further comprising
a detection means for detecting the generation of the target sound wave.

### (Supplementary Note 11)

A sound wave information output method comprising:
estimating, based on generation of a target sound wave that is a sound wave transmitted underwater, an emission source velocity that is a moving direction and a moving speed of an emission source that emits the target sound wave;
generating sound wave information including information of a transmission frequency of the target sound wave, based on the emission source velocity, a reception frequency of the target sound wave in a reception device that has received the target sound wave, a reception device velocity that is a moving direction and a moving speed of the reception device, and a sound speed in water around the reception device; and
outputting the sound wave information.

### (Supplementary Note 12)

The sound wave information output method according to Supplementary Note 11, wherein
the emission source velocity is estimated, based on position information of a vessel present in a predetermined range from the reception device.

### (Supplementary Note 13)

The sound wave information output method according to Supplementary Note 12, wherein
a vessel present in an arrival direction of the target sound wave with respect to the reception device is estimated as the emission source of the target sound wave.

### (Supplementary Note 14)

The sound wave information output method according to Supplementary Note 13, wherein
in a case where a plurality of vessels is present in the arrival direction of the target sound wave, a vessel that is no longer present in an arrival direction of the emission source is excluded from candidates for the emission source, based on a temporal change in the arrival direction of the target sound wave.

### (Supplementary Note 15)

The sound wave information output method according to any one of Supplementary Notes 11 to 14, further comprising:
estimating an emission source position that is a position of the emission source, wherein
the emission source velocity is estimated, based on a temporal change in the emission source position.

### (Supplementary Note 16)

The sound wave information output method according to any one of Supplementary Notes 11 to 15, wherein
the sound speed is estimated, based on a water temperature.

### (Supplementary Note 17)

The sound wave information output method according to Supplementary Note 16, wherein
the sound speed is estimated, further based on a salinity concentration around the reception device.

### (Supplementary Note 18)

The sound wave information output method according to any one of Supplementary Notes 11 to 17, wherein
the target sound wave is a sound wave not used in wireless communication using sound waves, between a wireless communication device present underwater and a base station.

### (Supplementary Note 19)

The sound wave information output method according to any one of Supplementary Notes 11 to 17, wherein
the target sound wave is an interference wave that is a sound wave that has a possibility to interfere with wireless communication using sound waves, between a wireless communication device present underwater and a base station.

### (Supplementary Note 20)

The sound wave information output method according to any one of Supplementary Notes 11 to 19, further comprising
detecting the generation of the target sound wave.

### (Supplementary Note 21)

A computer-readable recording medium recording a sound wave information output program
causing a computer to implement:
a velocity estimation function of estimating, based on generation of a target sound wave that is a sound wave transmitted underwater, an emission source velocity that is a moving direction and a moving speed of an emission source that emits the target sound wave;
a generation function of generating sound wave information including information of a transmission frequency of the target sound wave, based on the emission source velocity, a reception frequency of the target sound wave in a reception device that has received the target sound wave, a reception device velocity that is a moving direction and a moving speed of the reception device, and a sound speed in water around the reception device; and
an output function of outputting the sound wave information.

### (Supplementary Note 22)

The computer-readable recording medium recording a sound wave information output program according to Supplementary Note 21, wherein
the velocity estimation function estimates the emission source velocity, based on position information of a vessel present in a predetermined range from the reception device.

### (Supplementary Note 23)

The computer-readable recording medium recording a sound wave information output program according to Supplementary Note 22, wherein
the velocity estimation function estimates, as the emission source of the target sound wave, a vessel present in an arrival direction of the target sound wave with respect to the reception device.

### (Supplementary Note 24)

The computer-readable recording medium recording a sound wave information output program according to Supplementary Note 23, wherein
in a case where a plurality of vessels is present in the arrival direction of the target sound wave, the velocity estimation function excludes a vessel that is no longer present in an arrival direction of the emission source from candidates for the emission source, based on a temporal change in the arrival direction of the target sound wave.

### (Supplementary Note 25)

The computer-readable recording medium recording a sound wave information output program according to any one of Supplementary Notes 21 to 24, wherein
the sound wave information output program further causes a computer to implement an emission source position estimation function of estimating an emission source position that is a position of the emission source, and
the velocity estimation function estimates the emission source velocity, based on a temporal change in the emission source position.

### (Supplementary Note 26)

The computer-readable recording medium recording a sound wave information output program according to any one of Supplementary Notes 21 to 25, wherein
the generation function estimates the sound speed, based on a water temperature.

### (Supplementary Note 27)

The computer-readable recording medium recording a sound wave information output program according to Supplementary Note 26, wherein
the generation function estimates the sound speed, further based on a salinity concentration around the reception device.

### (Supplementary Note 28)

The computer-readable recording medium recording a sound wave information output program according to any one of Supplementary Notes 21 to 27, wherein
the target sound wave is a sound wave not used in wireless communication using sound waves, between a wireless communication device present underwater and a base station.

### (Supplementary Note 29)

The computer-readable recording medium recording a sound wave information output program according to any one of Supplementary Notes 21 to 27, wherein
the target sound wave is an interference wave that is a sound wave that has a possibility to interfere with wireless communication using sound waves, between a wireless communication device present underwater and a base station.

### (Supplementary Note 30)

The computer-readable recording medium recording a sound wave information output program according to any one of Supplementary Notes 21 to 29, wherein
the sound wave information output program further causes a computer to implement a detection function of detecting the generation of the target sound wave.

While the present disclosure has been particularly shown and described with reference to example embodiments thereof, the present disclosure is not limited to these example embodiments. It will be understood by those of ordinary skill in the art that various changes in form and details may be made therein without departing from the spirit and scope of the present disclosure as defined by the claims. And each example embodiment can be appropriately combined with other example embodiments.

This application is based upon and claims the benefit of priority from Japanese patent application No. 2023-148124, filed on Sep. 13, 2023, the disclosure of which is incorporated herein in its entirety by reference.

### REFERENCE SIGNS LIST

10, 20, 30, 40-i sound wave information output device
11, 21, 41-i velocity estimation unit
12, 22, 42-i generation unit
13, 23, 43-i output unit
24, 44-i detection unit
35 emission source position estimation unit
60 base station
50, 50-i wireless communication device
71, 72 communication system
90 information processing device
91 communication interface
92 input/output interface
93 computing device
94 storage device
95 nonvolatile storage device
96 drive device
97 recording medium

What is claimed is:

1. A sound wave information output device comprising one or more memories storing instructions and one or more processors configured to execute the instructions to:
estimate, based on generation of a target sound wave that is a sound wave transmitted underwater, an emission source velocity that is a moving direction and a moving speed of an emission source that emits the target sound wave;
generate sound wave information including information of a transmission frequency of the target sound wave, based on the emission source velocity, a reception frequency of the target sound wave in a reception device that has received the target sound wave, a reception device velocity that is a moving direction and a moving speed of the reception device, and a sound speed in water around the reception device; and
output the sound wave information.

2. The sound wave information output device according to claim 1, wherein
the emission source velocity is estimated, based on position information of a vessel present in a predetermined range from the reception device.

3. The sound wave information output device according to claim 2, wherein
a vessel present in an arrival direction of the target sound wave with respect to the reception device is estimated as the emission source of the target sound wave.

4. The sound wave information output device according to claim 3, wherein
in a case where a plurality of vessels is present in the arrival direction of the target sound wave, a vessel that is no longer present in the arrival direction of the target sound wave is excluded from candidates for the emission source, based on a temporal change in the arrival direction of the target sound wave.

5. The sound wave information output device according to claim 1, wherein
the processors are configured to execute the instructions to estimate an emission source position that is a position of the emission source, and
the emission source velocity is estimated, based on a temporal change in the emission source position.

6. The sound wave information output device according to claim 1, wherein
the sound speed is estimated, based on a water temperature.

7. The sound wave information output device according to claim 6, wherein
the sound speed is estimated, further based on a salinity concentration around the reception device.

8. The sound wave information output device according to claim 1, wherein
the target sound wave is a sound wave not used in wireless communication using sound waves, between a wireless communication device present underwater and a base station.

9. The sound wave information output device according to claim 1, wherein
the target sound wave is an interference wave that is a sound wave that has a possibility to interfere with wireless communication using sound waves, between a wireless communication device present underwater and a base station.

10. The sound wave information output device according to claim 1, wherein
the processors are configured to execute the instructions to detect the generation of the target sound wave.

11. A sound wave information output method comprising:
estimating, based on generation of a target sound wave that is a sound wave transmitted underwater, an emission source velocity that is a moving direction and a moving speed of an emission source that emits the target sound wave;
generating sound wave information including information of a transmission frequency of the target sound wave, based on the emission source velocity, a reception frequency of the target sound wave in a reception device that has received the target sound wave, a reception device velocity that is a moving direction and a moving speed of the reception device, and a sound speed in water around the reception device; and
outputting the sound wave information.

12. The sound wave information output method according to claim 11, wherein
the emission source velocity is estimated, based on position information of a vessel present in a predetermined range from the reception device.

13. The sound wave information output method according to claim 12, wherein
a vessel present in an arrival direction of the target sound wave with respect to the reception device is estimated as the emission source of the target sound wave.

14. The sound wave information output method according to claim 13, wherein
in a case where a plurality of vessels is present in the arrival direction of the target sound wave, a vessel that is no longer present in the arrival direction of the target sound wave is excluded from candidates for the emission source, based on a temporal change in the arrival direction of the target sound wave.

15. The sound wave information output method according to claim 11, further comprising:
estimating an emission source position that is a position of the emission source, wherein
the emission source velocity is estimated, based on a temporal change in the emission source position.

16. The sound wave information output method according to claim 11, wherein
the sound speed is estimated, based on a water temperature.

17. The sound wave information output method according to claim 16, wherein
the sound speed is estimated, further based on a salinity concentration around the reception device.

18. The sound wave information output method according to claim 11, wherein
the target sound wave is a sound wave not used in wireless communication using sound waves, between a wireless communication device present underwater and a base station.

19. The sound wave information output method according to claim 11, wherein
the target sound wave is an interference wave that is a sound wave that has a possibility to interfere with wireless communication using sound waves, between a wireless communication device present underwater and a base station.

20. A non-transitory computer-readable recording medium recording a sound wave information output program
causing a computer to implement:
a velocity estimation function of estimating, based on generation of a target sound wave that is a sound wave transmitted underwater, an emission source velocity that is a moving direction and a moving speed of an emission source that emits the target sound wave;
a generation function of generating sound wave information including information of a transmission frequency of the target sound wave, based on the emission source velocity, a reception frequency of the target sound wave in a reception device that has received the target sound wave, a reception device velocity that is a moving direction and a moving speed of the reception device, and a sound speed in water around the reception device; and
an output function of outputting the sound wave information.
